(19) United States
(12) Patent Application Publication
(10) Pub. No.: US 2004/0163345 A1
(43) Pub. Date: Aug. 26, 2004

(54) Blanket heat insulation with facing radiant barrier

(76) Inventor: Robert J. Alderman, Canyon Lake, TX (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/783,929

(22) Filed: Feb. 20, 2004

Related U.S. Application Data
(63) Continuation-in-part of application No. 10/186,454, filed on Jun. 28, 2002, now abandoned.
Application No. 10/186,454 is a continuation-in-part of application No. 10/039,101, filed on Jan. 4, 2002, now Pat. No. 6,557,313.

(51) Int. Cl. B32B 1/04; B32B 3/02

(52) U.S. Cl. 52/404.1; 52/406.1; 52/407.3

(57) ABSTRACT

The blanket heat insulation with facing radiant barrier includes a heat insulation blanket assembly (10) that is to be placed in a wall structure of a building. The heat insulation blanket assembly includes a blanket formed of fibrous materials such as fiberglass, with the fibers being arranged in random array and defining air gaps therebetween for insulation purposes. Flexible sheet material (26) is positioned in superposed relationship with respect to a broad surface of the blanket (12), and includes a reflective surface (42) that faces the blanket. The fibers of the blanket engage and support the flexible sheet material without requiring an adhesive or other connection therebetween. This leaves the air gaps between the fibers of the blanket exposed to the heat reflective surface of the flexible sheet material, so that the air gaps tend to maintain the reflective properties of the reflective surface of the flexible sheet material.

### CROSS REFERENCE TO RELATED APPLICATION

This application is a continuation-in-part of my prior U.S. patent application Ser. No. 10/186,454 filed Jun. 28, 2002, which is a continuation-in-part of my prior application Ser. No. 10/039,101 filed Jan. 4, 2002, now U.S. Pat. No. 6,557,313.

### FIELD OF THE INVENTION

This invention relates generally to heat insulation in building structures. More specifically, the present invention relates to a heat insulation blanket assembly which includes a blanket of heat insulation material and a radiant heat barrier adjacent the blanket material for retarding the transfer of radiant heat.

### BACKGROUND OF THE INVENTION

Heat insulation for building structures, used in attics, walls, floors, etc., typically comprises loose material that can be blown into place, particularly into attics, or blanket material that can be manually placed between parallel studs, joists, etc. Generally, the insulation material forms a network of air pockets or gaps that retard the transfer of heat by convection and conduction. The blanket material can comprise fiberglass, cellulose, mineral wool, and other particulate material that traps a multitude of air gaps or spaces between the fibers.

In addition to using the fibrous heat insulation material for convection and conduction insulation, it is also possible to use a heat reflective material to function as a radiant heat barrier. The radiant heat barrier can be used alone or in combination with the conduction and convection heat insulation. The radiant heat barrier can comprise a sheet material of foil that has a heat reflective surfaces on one or both of its sides. The foil can be attached to convection and conduction heat insulation for providing added radiant energy with reflective properties, thus adding to the total insulating value of the insulation assembly. Typically, the assembly would be placed between parallel joists, studs, etc of an outside wall of a building structure. However, it has been found that when the reflective foil sheet material makes contact with adjacent surfaces, the foil loses its heat reflective properties in its areas where contacted.

Because of the discovery of this characteristic, my recent developments provide a heat reflective insulation sheet material configured to make sure that the reflective surface of the sheet material does not contact adjacent structures. For example, my U.S. Pat. No. 5,918,436 discloses an insulating facing material having multiple sheet materials of foil of different areas attached together at their edges so that when suspended between parallel joists, etc., the lower sheet material sags due to gravity a distance away from the upper sheet material. This creates an air gap between the reflective sheet materials. This air gap that is trapped between the sheet materials functions as insulation from convection and conduction heat transfer. The enclosed space formed by the two overlying sheet materials prevents the invasion of dust, stray fibers, grit, sawdust, etc. that might otherwise make contact with the internal reflective surface. This maintains the reflective capability of the surface.

My more recent U.S. Pat. No. 6,557,313 teaches the use of sheet material applied to a surface of insulation blanket material with a reflective surface of the sheet material facing away from the blanket material toward the an adjacent wall board. Spacers are supported by the reflective sheet material and are positioned to maintain a space between the reflective surface and the wall board.

While the radiant barrier concept as disclosed in my U.S. Pat. No. 5,918,436 is effective and efficient, there is a need to provide an effective radiant barrier in combination with blanket insulation with the radiant barrier being able to make contact with the blanket insulation without losing the majority of its heat reflective properties. This would avoid having to maintain a space between the heat reflective sheet material and the next adjacent structure.

It is to this endeavor that this invention is directed.

### SUMMARY OF THE INVENTION

Briefly described, the present invention comprises an insulating system which limits not only heat of convection and conduction, but also limits heat of radiation, to reduce and retard heat transfer between adjacent spaces. Typically, the insulating device would be used in building structures, in walls between spaces of different temperatures, such as in exterior walls, floors, and ceilings, to retard the transfer of heat between these spaces.

More specifically, the present invention relates to a heat insulation blanket assembly that includes an elongated blanket of fibrous material having at least one broad surface formed of fibrous material. The blanket typically will be in rectangular cross section with opposed broad surfaces and with opposed side surfaces joining the opposed broad surfaces. Flexible sheet material is placed in superposed relationship with respect to at least one of the opposed broad surfaces bearing a fibrous surface. The sheet material bears a heat reflective surface facing the fibrous surface of the blanket. The fibrous surface of the blanket has surface fibers that engage the heat reflective surface of the sheet material, so that the engaging fibers support the reflective surface of the sheet material.

In one embodiment of the invention, the engaging fibers of the blanket are spaced apart sufficiently so as to provide air gaps between themselves, with the air gaps being placed in contact with the heat reflective surface of the flexible sheet material. The fibers that engage the reflective surface tend to diminish the reflective properties of the flexible sheet material at the point of engagement; however, the air gaps that are formed throughout the interstices of the surface fibers and the reflective surface continue to provide an array of unobstructed small spaces adjacent the reflective surface, thereby preserving the reflective properties of the reflective surface.

In an embodiment of the invention the multitude of surface fibers that support the reflective surface of the flexible sheet material are shaped in a random array with a random array of air gaps formed therebetween in contact with the surface of the reflective sheet material, so that the reflectivity of the reflective surface is substantially uniform across the breadth of the reflective sheet material. The fibers are spaced from one another such that at least 80% of the heat reflective capability of the reflective surface is maintained.

Because the reflective surface of the flexible sheet material faces the blanket, the reflective surface is protected from outside sources of dust, grime, dirt, and other items that might accumulate on the flexible sheet material during manufacture, storage, installation and use of the heat insulation blanket assembly. This tends to assure that the reflective capability of the reflective surface will not be diminished from these sources during its life of use.

In an embodiment disclosed herein, the reflective flexible sheet material is extended about one of the broad surfaces of the blanket that bears a fibrous face and the opposed side surfaces of the blanket, forming a U-shape in cross section, and a layer of Kraft paper is extended about the opposed broad surface of the blanket. The Kraft paper is adhesively bonded to the facing surface of the blanket. The side edges of the Kraft paper extend beyond the sides of the blanket, and the edges of the flexible sheet material are bonded to the edges of the Kraft paper. The bonding of the flexible sheet material to the Kraft paper holds the flexible sheet material to the assembled structure. This completely surrounds the cross sectional shape of the blanket with Kraft paper and the flexible sheet material, thereby reducing the likelihood of the introduction of foreign objects, such as dirt, grime, dust, moisture, etc. to the interior blanket.

The flexibility of the sheet material allows the blanket assembly to be reduced in height and even formed into a spiral when stored or shipped. When the reduced height blanket assembly is freed from its constraints, the internal blanket tends to expand back to its relaxed shape. Ultimately, the improved heat insulation blanket assembly is installed in the walls of a building structure, such as ceilings, exterior walls, internal walls, and floors of the building structure.

One embodiment of the invention has the broad surface of the blanket formed with an irregularly shaped surface and the reflective sheet material superposed the irregularly shaped surface. The irregularly shaped surface of the blanket may include raised and lowered surfaces areas formed by tufts of upstanding layers or portions of the fibrous material at the surface of the blanket. The tufts form air gaps there between and support and suspend the reflective sheet material away from the other surface areas of the blanket.

The shaped surface of the blanket material can be in the form of an array of corrugations, protrusions and other more uniform configurations that form a raised array of protrusions and an array of intermediate spaces that form air gaps. The air gaps in the intermediate array of spaces contact the facing reflective surface of the sheet material and maintain the reflective properties the reflective surface of the sheet material at their positions on the reflective surface.

Preferably, the fibrous layer of the blanket facing the reflective sheet material and the reflective surface of the sheet material should be maintained free of substances that might impair the reflectivity of the reflective sheet material, such as paint and adhesive that would contact the reflective surface and tend to impair the reflectivity of the surface. However, if it is desired that the reflective sheet material should be bonded to the fibrous surface of the blanket, adhesive can be applied to the fibrous surface of the blanket and adhered to the facing surfaces of the sheet material. The adhesive should be applied in small amounts at intervals on the face of the blanket to avoid contacting as much of the surface of the sheet as possible. This leaves the intermediate air gaps between the places where the adhesive was applied and the facing portions of the reflective surface free of the adhesive. Preferably, the adhesive would be applied to raised portions of the fibrous surface of the blanket so as to leave as much of the reflective surface free of adhesive as possible.

Thus, it is an object of this invention to provide a heat insulation blanket assembly that includes a blanket having a fibrous surface and a heat reflective sheet material, such as foil, that has a reflective surface that is applied to the fibrous surface in a configuration that preserves the reflective properties of the sheet material.

Another object of this invention is to provide an improved method of insulating a building structure, for retarding convection, conduction and radiant heat transfer between spaces in and about the building structure, whereby the reflective surface of a flexible sheet material can be placed in contact with a fibrous surface of an adjacent heat insulation blanket and maintain a substantial portion of its heat reflective capability.

Another object of the invention is to provide an inexpensive, durable, and easy to install blanket insulation assembly in building structures.

Another object of the invention is to provide a building structure that has heat insulated walls that provide improved conduction, convection and radiant heat insulation.

Another object of the invention is to provide a building structure having improved convection, conduction and radiant heat insulation that is expedient to install and is durable.

Other objects, features and advantages of the present invention will become apparent upon reading the following specification, when taken in conjunction with the accompanying drawings.

### BRIEF DESCRIPTION OF THE DRAWINGS

FIG. 1 is a cross-sectional isometric view of a heat insulation blanket assembly for a building structure that is to be used for retarding the transfer of heat between adjacent spaces of the building structure.

FIG. 2 is a detailed illustration of the fibrous blanket and the flexible sheet material applied to a surface of the fibrous blanket.

FIG. 3 is a cross-sectional isometric view of a heat insulation blanket assembly, similar to FIG. 1, but showing the heat reflective surface applied to a sheet material insert.

FIG. 4 is a detailed illustration of the heat insulation blanket assembly of FIG. 3.

FIG. 5 is a schematic illustration of how the flexible reflective sheet material and the Kraft paper are applied to the fibrous blanket.

FIG. 6 is a cross-sectional view of a typical wall structure that embodies the invention.

FIG. 7 is a cross-sectional isometric view of a second embodiment of the blanket assembly.

FIG. 8 is a detailed illustration of the second embodiment of the blanket assembly.

FIG. 9 is a cross-sectional isometric view of another embodiment of the blanket assembly.

### DETAILED DESCRIPTION

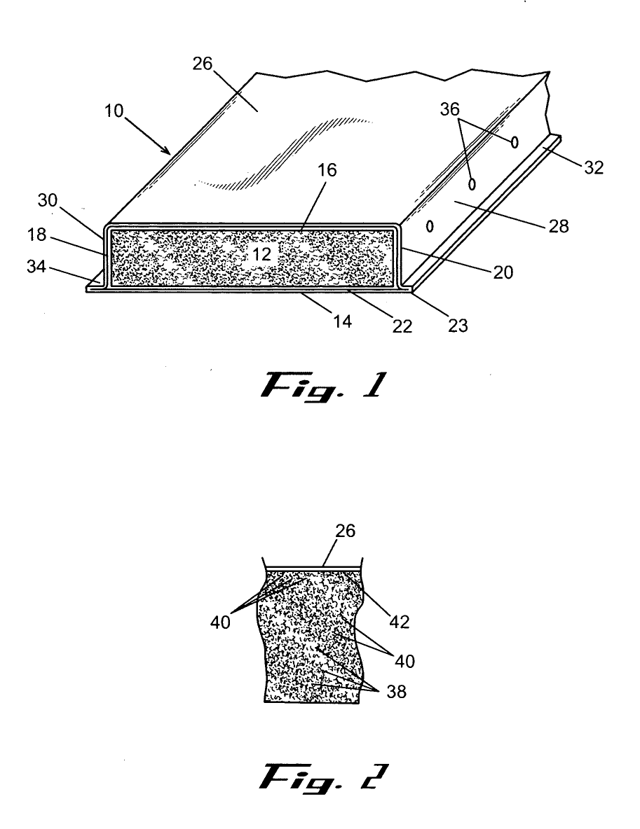

Referring now in more detail to the drawings, in which like numerals indicate like parts throughout the several views, FIG. 1 shows a heat insulation blanket assembly 10 that includes an elongated blanket of fibrous material 12 that is rectangular in cross-section. The blanket has first and second opposed broad surface 14 and 16, and side surfaces 18 and 20 that join the opposed broad surfaces.

A layer of Kraft paper 22 extends along the length of the blanket in superposed relationship with the first broad surface 14. The Kraft paper is bonded to the facing first broad surface 14, and clings thereto. The side edge portions 23 and 24 of the Kraft paper extend beyond the breadth of the blanket 12.

Flexible sheet material 26 also extends along the length of the blanket in superposed relationship with the second broad surface 16 of the blanket, with its side portions 28 and 30 turned about the side surfaces 18 and 20 of the blanket. The side edges 32 and 34 of the flexible sheet material 26 are turned outwardly and are superposed the side edge portions 23 and 24 of the Kraft paper, and are adhered thereto. Thus, the flexible sheet material 26 and the Kraft paper 22 surround the cross-sectional shape of the blanket 12, and protect the blanket from accumulation of dust, debris, grime, moisture, etc. from an outside source.

In order to make sure that the blanket 12 reaches its full dimensions after having been stored or packed, and therefore compressed, air openings 36 are formed in the side portions 28 and 30 of the sheet material 26, allowing air to be expelled from the blanket when the blanket is being compressed or allowing air to be induced into the enclosure formed by the layer of Kraft paper 22 and the flexible sheet material 26 when the blanket expands.

As illustrated in FIG. 2, the insulation blanket 12 can be formed from a mass of fibers. For example, the fibers can be fiberglass, mineral wool, or cellulose, which comprise randomly oriented fibers. The principle of using the fibrous material as the blanket is to form air gaps or pockets of air throughout the blanket. For example, the fibers 38 are randomly oriented throughout the blanket, and air gaps 40 are formed between the fibers.

In an embodiment of the invention in which the blanket is formed of fiberglass, the blanket is formed of fiberglass and air, with the fibers formed in a density of from 0.25 to 1.0 pounds per cubic foot. A preferred range of density of fiberglass in the blanket is from 0.5 to 0.8 pounds per cubic foot. The most common density of the fiberglass is 0.6 pounds per cubic foot since this is a common commercial grade of fiberglass. The fiberglass of greater density (more glass per cubic foot) has less air space between the fibers and therefore may not have the desired insulation capability. The fiberglass of lower density has stronger and fewer fibers and more air space between the fibers but forms a stiffer blanket that may not be flexible enough for ease of shipment and/or installation in a building structure. Since the flexible sheet material is so light weight, the fibers of the blanket in the preferred range of fiber density can easily support the flexible sheet material.

The flexible sheet material 26 bears a reflective surface that faces the blanket 12. The flexible sheet material can be formed of aluminum foil or other metal foils, metalized polyester or metalized polyethylene. The opposite surface of the sheet may also be heat reflective for providing maximum reflection of heat.

A feature of the invention is the location of the air gaps 40 adjacent the reflective surface 42. The surface fibers at the facing surface of the blanket engage and support the flexible sheet material 26 without requiring an adjacent bonding surface, such as adhesive, paint, or other material or mechanical means that would cling between the flexible sheet material and the blanket 12. This leaves the air gaps 40 open about the fibers 38, so that a lattice or array of air gaps is maintained immediately adjacent the reflective surface 42 of the flexible sheet material 26. While the fibers 38 tend to occlude or block the reflective capability of the reflective surface of the flexible sheet material 26, the adjacent air gaps tend to maintain the reflective properties of the reflective surface of the flexible sheet material.

The area of contact of the air gaps 40 against the reflective surface 42 of the flexible sheet material 26 is greater than the area of contact of the fibers 38 against the flexible sheet material. Thus, in spite of the use of the fibers to support the flexible sheet material, and in spite of the contact made by the fibers against the flexible sheet material, it is estimated that over 80% of the heat reflective capability of the reflective surface of the flexible sheet material is maintained in this configuration with a blanket made from fiberglass as described above.

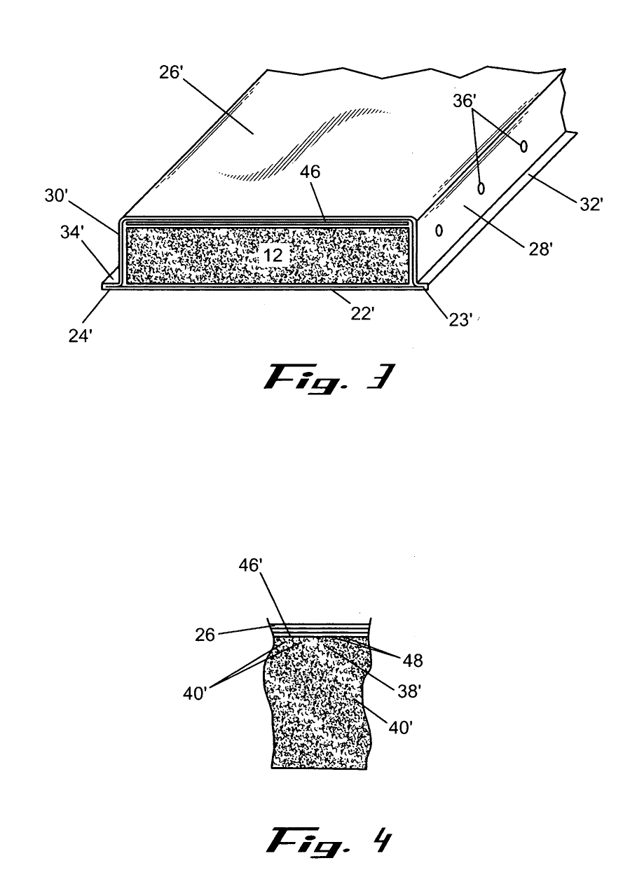

FIGS. 3 and 4 show a second embodiment of the invention, whereby an additional sheet material 46 is placed between the blanket 12′ and the flexible sheet material 26′. In this embodiment, the flexible sheet material 26′ does not have to be formed with a heat reflective surface. The additional sheet material 46 has a heat reflective surface that faces the blanket 12′. The other elements of the embodiment of FIG. 3 are similar to those of FIG. 1, such as the Kraft paper 22′, side edge portions 23′ and 24′, the side portions 28′ and 30′ of the flexible sheet material 26′, the side edges 32′ and 34′, and the air openings 36′. Thus, the embodiment of FIG. 3 can utilize separate materials for forming the flexible sheet material 26′ and the reflective sheet material 46. For example, the reflective sheet material 46 can be made of very thin aluminum foil while the flexible sheet material 26 can be made of a more protective material, such as polyester or polyethylene.

FIG. 4 shows that the principle of operation of the embodiment of FIGS. 3 and 4 is the same, in that air gaps 40′ are formed about the fibers 38′ at the reflective surface 48 of the reflective sheet material 46.

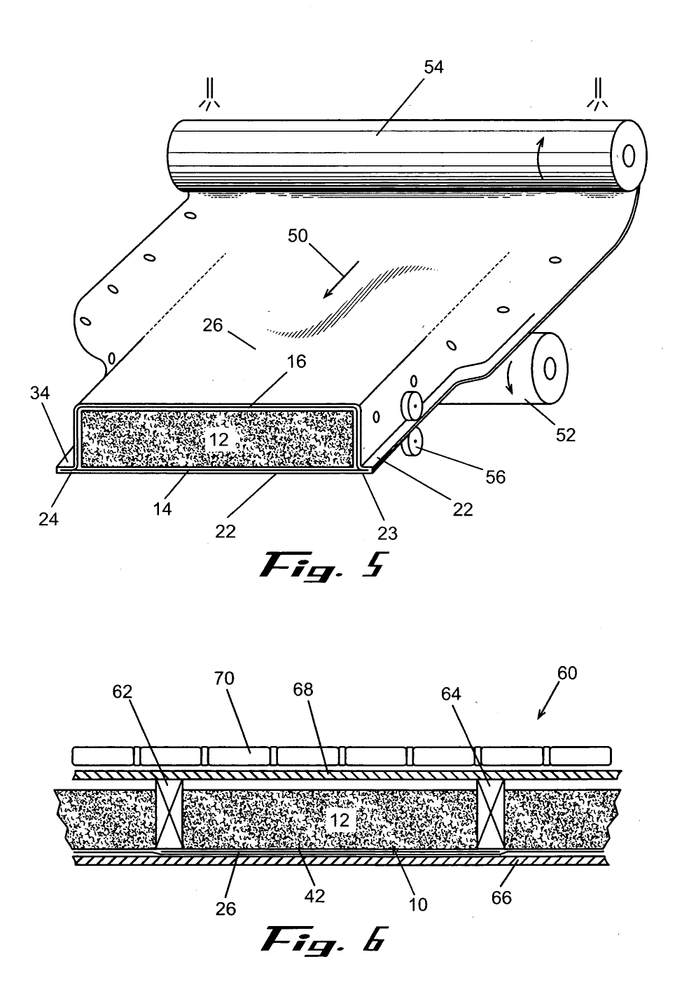

FIG. 5 is a schematic illustration of the process of forming the heat insulation blanket assembly of FIGS. 1 and 2. A continuous length of blanket material 12 is advanced along its length in the direction indicated by arrow 50, and as it is advanced, Kraft paper 22 is paid out from a supply 52 and moved in the same direction. The Kraft paper is coated with adhesive and the adhesive bonds the Kraft paper to the first broad surface 14 of the blanket 12. In the meantime, the flexible sheet material 26 is advanced from its supply in the same direction and is formed in an inverted U-shape about the blanket 12. The edges 23, 32 and 24, 34 are formed in overlying relationship and are bonded together by heat fusing, adhesive, or other conventional means schematically indicated at 56.

In the situation where the embodiment of FIG. 3 is to be formed, the supply 54 of the flexible sheet material is preformed with the additional reflective sheet material 46 (not shown in FIG. 5) so as to be applied to the facing second broad surface 16 of the blanket 12.

As illustrated in FIG. 6, the heat insulation blanket assembly 10 is installed in a conventional wall structure 60 of a building that includes upright parallel studs 62 and 64, the heat insulation blanket assembly 10 positioned between the studs with the side portions forming connector flanges that are easily attached to a surface of the studs by staples, nails, adhesive, etc. Gypsum board 66 is applied in the conventional manner to the studs 62 and 64 on the interior of the wall structure, and ply board or other rigid sheet material 68 is applied to the opposed surfaces of the studs, to face the exterior of the building structure. A facade such as brick 70, clapboard, stucco, or other conventional building materials typically will be applied to the external sheet material 68.

In the embodiment shown in FIG. 6, the heat reflective surface 42 of the flexible sheet material 26 is positioned between the blanket 12 and the interior of the building structure. However, the heat insulation blanket assembly 10 can be reversed in the wall structure so as to place the flexible sheet material 26 and its reflective surface 42 between the blanket 12 and the exterior of the building.

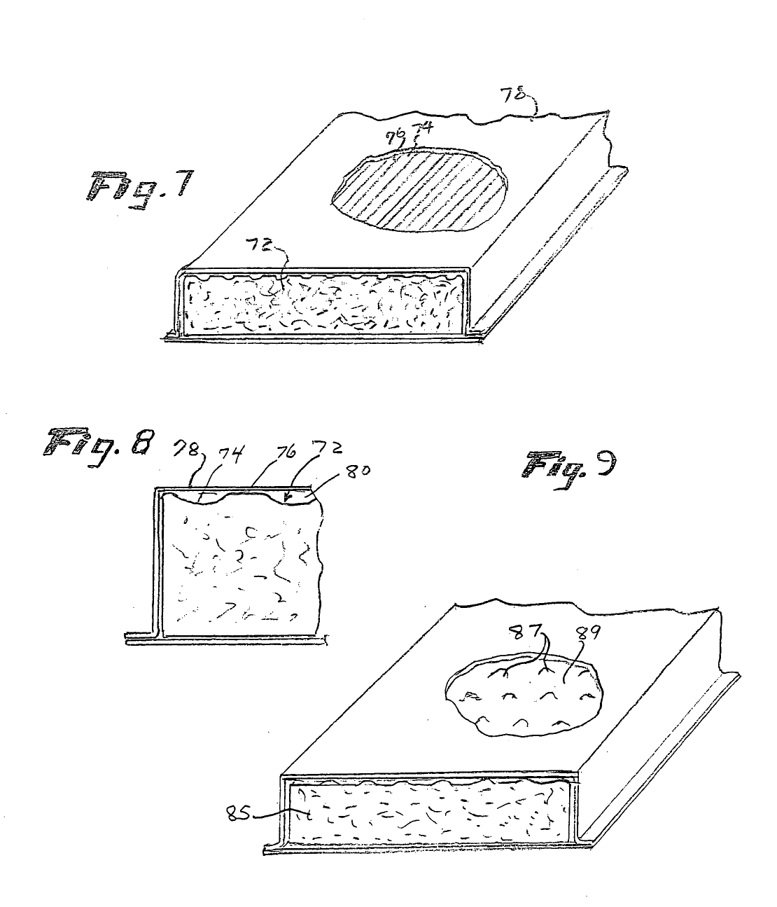

FIGS. 7 and 8 illustrate an embodiment of the invention in which the fibrous surface of the blanket 75 is configured with a shaped surface having high areas and low areas. The illustrated embodiment has a fibrous surface 72 shaped in the form of corrugations extending along the length of the blanket. The corrugations may extend across the length of the blanket if desired. The low areas 74 of the corrugations are formed between the high ribs 76 of the corrugations. The high ribs support the sheet material 78 away from the low areas 74 and form the air gaps 80 between the sheet material and the fibrous face of the blanket 75.

FIG. 9 illustrates another embodiment of the invention in which the fibrous surface of the blanket 85 is formed with protrusions or tufts 87 extending therefrom with low areas 89 there between. As with the embodiment of FIGS. 7 and 8, the protrusions 87 are higher than the low areas 89 and hold the reflective surface of the sheet material 90 away from the low areas, and form air gaps adjacent the reflective surface, preserving the reflective properties of the reflective surface that is not in contact with the blanket.

Another embodiment of the invention is the formation of an irregularly shaped fibrous surface of the blanket, generally similar to that of FIG. 9, but with less uniform positioning and sizes of the protrusion, with the irregular shaped surface having high and low areas, with the high areas holding the reflective surface of the sheet material away from a major portion of the surface of the blanket.

The drawings show the reflective sheet material positioned in abutment with the fibers of the blanket; however, if the heat insulation blanket assembly is oriented with the reflective sheet material below the blanket, the reflective sheet material is likely to sag away from the blanket due to the influence of gravity. When this happens, the reflective sheet material is likely to have less of its surface occluded by the fibrous material and therefore be even more reflective.

If desired, adhesive may be applied to the higher protruding ribs of the corrugated surface of the blanket of FIGS. 7 and 8, or to the higher protrusions/tufts of FIG. 9, so that the sheet material contacts and adheres to the blanket. The lower areas between the ribs and tufts, etc. will still preserve the air gaps in contact with the reflective surface of the sheet material, thereby preserving the reflective properties of these portions of the sheet material.

Also, adhesive material can be applied to the surface of the blanket in small dots spaced from one another on the surface of the blanket. This assures that the adhesive does not have the potential of covering substantial portions of the reflective surface of the sheet material.

While the invention has been disclosed with the blanket 12 formed of fibrous materials, such as fiberglass, the blanket can be formed of other non-fibrous materials and only the surface facing the flexible sheet material and its heat reflective surface can be made of fibrous materials, so that a mass of surface fibers is positioned at the position that contacts the reflective surface, so as to provide the desired air gaps at the reflective surface.

Although preferred embodiments of the invention has been disclosed in detail herein, it will be obvious to those skilled in the art that variations and modifications of the disclosed embodiments can be made without departing from the spirit and scope of the invention as set forth in the following claims.

I claim:

1. A heat insulation blanket assembly for a building structure for retarding the transfer of heat between spaces in and about the building structure, comprising:
an elongated blanket of fibrous material having first and second opposed surfaces and opposed side surfaces joining the opposed surfaces,
a layer of Kraft paper extending along the length of the blanket superposed the first surface and adhesively bonded to the first surface,
sheet material extending along the length of the blanket superposed the second surface, the sheet material bearing a heat reflective surface facing the second surface of the fibrous blanket,
the fibrous blanket having surface fibers positioned at the second surface for engaging the heat reflective surface of the sheet material, the surface fibers being spaced from one another a distance to form an array of air gaps in contact with at least 80% of the reflective surface of the sheet material,
such that the surface fibers of the second surface of the blanket support the sheet material with the air gaps between the surface fibers maintaining the reflectivity of the reflective surface of the sheet material about the surface fibers.

2. The heat insulation blanket assembly of claim 1, wherein the second surface of the blanket includes an array of protrusions extending therefrom with air gaps formed between the protrusions and the heat reflective surface of the sheet material, with the protrusions holding the reflective surface of the sheet material away from the spaces between the protrusions.

3. The heat insulation blanket assembly of claim 2, wherein the protrusions are corrugations with alternating high and low ribs facing the heat reflective surface of the sheet material and the high ribs holding the heat reflective surface away from the low ribs of the blanket.

4. The heat insulation blanket assembly of claim 1, wherein the sheet material surrounds the second surface and the opposed side surfaces of the blanket and is bonded to the Kraft paper.

5. The heat insulation blanket assembly of claim 1, wherein the blanket is formed of material selected from the group consisting of fiberglass, mineral wool, and cellulose.

6. The heat insulation blanket assembly of claim 1, wherein the sheet material is selected from the group consisting of: polyester having a metal surface, polyethylene with a metalized surface, and aluminum.

7. The heat insulation blanket assembly of claim 2, and further including adhesive applied to the protrusions of the blanket and to the portion of the heat reflective surface facing the protrusions such that the heat reflective surface clings to the protrusions of the blanket and forms air gaps between the protrusions with the air gaps in contact with the reflective surface of the sheet material.

8. The heat insulation blanket assembly of claim 3, and further including adhesive applied to the high ribs of the corrugated surface of the blanket and to the portion of the heat reflective surface facing the high ribs such that the heat reflective surface clings to the high ribs of the blanket and the low ribs form air gaps with the heat reflective surface in contact with the heat reflective surface of the sheet material.

9. The heat insulation blanket assembly of claim 1, wherein the air gaps between the surface fibers engage more area of the sheet material than the surface fibers.

10. The heat insulation blanket assembly of claim 1, wherein the sheet material has a series of spaced air openings formed therein for the passage of air into and out of the blanket.

11. The heat insulation blanket assembly of claim 1, wherein the layer of Kraft paper extends beyond the sides of the blanket and forms mounting strips along the sides of the blanket for mounting the heat insulation blanket to adjacent structures.

12. The heat insulation blanket assembly of claim 11, wherein the sheet material is connected to the mounting strips.

13. The heat insulation blanket assembly of claim 1, wherein the sheet material is loosely maintained at the second surface of the blanket and is suspended away from the blanket when supported by the Kraft paper in a position below the blanket.

14. A heat insulation blanket assembly for retarding the transfer of heat between adjacent spaces, comprising:
an elongated blanket of heat insulation material having a fibrous surface,
sheet material extending along the elongated blanket superposed the fibrous surface,
the sheet material bearing a heat reflective surface facing the fibrous surface of the blanket,
the fibrous surface having surface fibers in engagement with the heat reflective surface of the sheet material and the surface fibers are of a density sufficient to maintain an array of air gaps formed about at least 80% of the heat reflective surface,
such that the air gaps maintain the reflective properties of at least 80% of the heat reflective surface of the sheet material.

15. The heat insulation blanket assembly of claim 14, wherein the blanket is formed of material selected from a group consisting of fiberglass, mineral wool and cellulose.

16. The heat insulation blanket assembly of claim 14, wherein the sheet material is selected from the group consisting of: polyester having a metalized surface, polyethylene with a metalized surface, and aluminum.

17. The heat insulation blanket assembly of claim 14, wherein the air gaps between the surface fibers engage more area of the sheet material than the surface fibers.

18. The heat insulation blanket assembly of claim 14, wherein the sheet material has a series of spaced air openings formed therein for the passage of air into and out of the blanket.

19. The heat insulation blanket assembly of claim 14, and further including a layer of Kraft paper extending on one side of the blanket and with the sheet material extending on the other side of the blanket, and with the Kraft paper and sheet material connected to each other and surrounding the cross section of the blanket.

20. The heat insulation blanket assembly of claim 14, wherein the sheet material is loosely maintained in superposed relationship with respect to the blanket and is suspended away from the blanket when positioned below the blanket.

21. The heat insulation blanket assembly of claim 14, wherein the sheet material comprises foil.

22. The heat insulation blanket assembly of claim 14, and further including adhesive applied between the blanket and the sheet material at space intervals on the insulation blanket and bonding the sheet material at spaced intervals to the blanket.

23. A method of insulating a building structure for retarding heat transfer between spaces in and about the building structure, comprising:
providing a blanket of heat insulation with a fibrous surface that forms air gaps over at least 80% of the fibrous surface,
providing a sheet material having a heat reflective surface,
placing the heat reflective surface of the sheet material in superposed relationship with the fibrous surface of the blanket,
supporting the sheet material with the fibers of the fibrous surface of the blanket with at least 80% of the reflective material contacted with the air gaps, and
maintaining the reflectivity of the heat reflective surface of the sheet material with air gaps between the fibers of the fibrous surface that support the sheet material.

24. The method of insulating a building structure of claim 23, and further including the step of:
placing a sheet material of Kraft paper on one side of the blanket, and
extending the sheet material about the opposite side of the blanket and attaching the sheet material to the Kraft paper to surround the blanket.

25. A heat insulated wall structure for a building structure positioned between an interior heat controlled space of the building structure and the outside environment adjacent the building structure, comprising:
a series of spaced parallel support members,
a heat insulation blanket assembly positioned between the parallel support members,
wall board applied to the spaced parallel support members between heat insulation blanket assembly and the temperature controlled space of the building structure,
the blanket assembly including an elongated fibrous blanket of heat insulation material and including a fibrous surface,
sheet material having a heat reflective surface applied to the fibrous surface of the blanket,
the fibrous surface of the heat insulation blanket having surface fibers in engagement with the heat reflective surface of the sheet material and the surface fibers being of a density sufficient to maintain an array of air gaps formed about 80% of the surface of the heat reflective surface,
such that the air gaps maintain the reflective properties of at least 80% of the heat reflective surface of the sheet material.

26. The heat insulated wall structure of claim 24, wherein the sheet material is metal foil.

27. The heat insulated wall structure of claim 24, wherein the fibrous surface is an irregularly shaped surface.

28. The heat insulated wall structure of claim 26, wherein the irregularly shaped fibrous surface is selected from shapes consisting of corrugations, protrusions, random shapes and repetitive protruding shapes.

29. A heat insulation blanket assembly for a building structure for retarding the transfer of heat between spaces in and about the building structure, comprising:
an elongated blanket of fibrous material having a broad surface,
sheet material extending along the length of the blanket superposed the broad surface, the sheet material bearing a heat reflective surface facing the broad surface of the fibrous blanket,
the fibrous blanket having surface fibers positioned at the broad surface for engaging the heat reflective surface of the sheet material, the surface fibers being spaced from one another a distance to form an array of air gaps in contact with the reflective surface of the sheet material, a support sheet positioned on the opposite side of the blanket from the broad surface of the blanket and joined at its edges to the edges of the sheet material such that the sheet material and the support sheet surround the blanket,
such that the surface fibers of the broad surface of the blanket support the sheet material with the air gaps between the surface fibers maintaining the reflectivity of the reflective surface of the sheet material about the surface fibers.
